(19) United States
(12) Patent Application Publication
(10) Pub. No.: US 2008/0178253 A1
(43) Pub. Date: Jul. 24, 2008

(54) User Access Policy for Storing Offline

(76) Inventor: Antti Laurila, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/625,443

(22) Filed: Jan. 22, 2007

(51) Int. Cl. G06F 17/00

(52) U.S. Cl. 726/1

(57) ABSTRACT

A method, a computer program product, apparatuses and a system are shown for determining whether a predetermined user is accessible via a communication system, wherein it is intended to provide data to the predetermined user via the communication system, and in case the user is not accessible, deciding whether to store or not to store the data in a storage entity depending on an offline rule associated with the user, wherein the offline rule contains at least one out of (i) at least one accept rule for storing data, and (ii) at least one reject rule for not storing data.

### FIELD OF THE INVENTION

This invention relates to a method, a computer program product, apparatuses and a system for managing offline storage in a communication system.

### BACKGROUND OF THE INVENTION

A communication system can be seen as a facility that enables communication between two or more entities such as a user terminal and/or other nodes associated with the communication system. Subscribers, such as the users or end-users, to a communication system may be offered and provided numerous services wherein data is provided to the subscribers, such as calls, data communication or multimedia services or simply an access to a network, such as the Internet. For instance the services may be offered by an operator of the communication system or by an external service provider.

Services offered to subscribers of a communication system may comprise conferencing services, such as multiparty conferencing, for example, so-called direct voice communication services. The direct voice communication service may allow users to engage in immediate communication with one or more users. One example of the direct voice communication services may comprise the “push to talk over cellular” (PoC) service also known as the PTT (push-to-talk service). The PoC may be based on Voice over IP (VOIP) technology in cellular networks, such as the GSM/GPRS network.

Services offered to subscribers of a communication system may comprise instant messaging. The instant messaging communication service may allow users to send messages to one or more users.

Open Mobile Alliance (OMA)

OMA-TS-PoC-System-Description-V2_{—}0-20061221-D, Push to Talk over Cellular System Description, Version 2.0—21 Dec. 2006, defines the PoC, which is based on half-duplex communications. Thus, one user subscribing to the PoC service, i.e. a first PoC subscriber, and belonging to a group may speak at the time and the other users, or PoC subscribers, belonging to the group may listen but may not talk at the same time. The first PoC subscriber may press and hold a push-to-talk key on his communication device to start talking and the first PoC subscriber can now talk for as long as he holds the key. Similar principles apply with devices having touch sensitive or sound activated user interfaces. The first PoC subscriber is connected to the other users via a PoC server, wherein this PoC server is configured to control the PoC session and to route the content submitted from the first PoC subscriber to the other users.

PoC 2.0 introduces a new functionally called PoC Box, which stores PoC communications of a user to a network storage when the user is offline. Thus, in case one of the other user is not accessible via the PoC network, i.e. the user is offline, then the PoC server may store the data of the PoC communications of the non-accessible user to the PoC Box so that this user can retrieve this PoC communication data when he gets back to online.

This solution shows the disadvantage that the non-accessible user has no influence regarding the storage process to the network storage. E.g., the user does not want to store and receive content from certain users or groups, or the user does not want to store content having a huge data size.

The same problem may occur concerning the Instant Messaging (IM) service defined in OMA-AD-IM_SIMPLE_V1_{—}0-20061107-D, Instant Messaging using SIMPLE Architecture, Version 1.0—7 Nov. 2006, wherein a similar kind of functionality called deferred message is introduced, where a network stores messages sent to user when user is offline and forwards saved messages to user when he gets back online.

### SUMMARY

A method is disclosed, comprising determining whether a predetermined user is accessible via a communication system, wherein it is intended to provide data to said predetermined user via said communication system, and, in case said user is not accessible, deciding whether to store or not to store said data in a storage entity depending on an offline rule associated with said user, wherein said offline rule contains at least one out of:
at least one accept rule for storing data, and
at least one reject rule for not storing data.

Furthermore, a computer-readable medium having a computer program stored thereon is disclosed. The computer program comprises instructions operable to cause a processor to determine whether a predetermined user is accessible via a communication system, wherein it is intended to provide data to said predetermined user via said communication system, and, in case said user is not accessible, to decide whether to store or not to store said data in a storage entity depending on an offline rule associated with said user, wherein said offline rule contains at least one out of:
at least one accept rule for storing data, and
at least one reject rule for not storing data.

Furthermore, a computer program is disclosed, comprising instructions operable to cause a processor to determine whether a predetermined user is accessible via a communication system, wherein it is intended to provide data to said predetermined user via said communication system, and, in case said user is not accessible, to decide whether to store or not to store said data in a storage entity depending on an offline rule associated with said user, wherein said offline rule contains at least one out of:
at least one accept rule for storing data, and
at least one reject rule for not storing data.

Furthermore, an apparatus is disclosed, comprising a processing component configured to determine whether a predetermined user is accessible via a communication system, wherein it is intended to provide data to said predetermined user via said communication system, and, in case said user is not accessible, to decide whether to store or not to store said data in a storage entity depending on an offline rule associated with said user, wherein said offline rule contains at least one out of:
at least one accept rule for storing data, and
at least one reject rule for not storing data.

Furthermore, a system is disclosed, comprising said apparatus, said storage entity, and at least one interface configured to connect at least one user to said system.

Furthermore, an apparatus is disclosed, comprising means for determining whether a predetermined user is accessible via a communication system, wherein it is intended to provide data to said predetermined user via said communication system, and, in case said user is not accessible, for deciding whether to store or not to store said data in a storage entity depending on an offline rule associated with said user, wherein said offline rule contains at least one out of:
at least one accept rule for storing data, and
at least one reject rule for not storing data.

According to the method, computer program product, computer program, apparatus and system of the present invention, a user has influence regarding the storage process of data to the storage entity by means of the offline rule, since the user can define rules being used for deciding which data should be stored and which data should not be stored when he is offline.

For instance, the communication system may comprise one network or a plurality of networks being connected to each other, and the communication system may be configured to provide at least one service to a plurality of users. For instance, said communication system may enable multiparty conferencing between a plurality of users, for example, so-called direct voice communication services. The direct voice communication service may allow a first user to engage immediate communication with one or more users, e.g. one example of the direct voice communication service may comprise “push to talk over cellular” (PoC) service also known as the PTT (push-to-talk) service. The PoC may be based on Voice over IP (VOIP) technology in cellular networks, such as the GSM/GPRS network, wherein the PoC data is first transmitted from the first user to the communication system, e.g. to a server in said communication system, and then the communications system may distribute the PoC data to a predetermined at least one user selected by the first user. But also single point to single point services from the first user to another user may be offered by said communication system. E.g., another service offered to users may comprise instant messaging, which allows a user to send messages to one or more via the communication system.

In these exemplary cases, data has to be provided via a communication system to at least one user, i.e. to at least one predetermined user. There may exist other cases where data has to provide via a communication system to at least one predetermined user.

According to the present invention, it is intended to provide data to said predetermined user via said communication system, and it is determined whether this predetermined user is accessible via the communication system.

In case the predetermined user is accessible, then the data may be directly transmitted to said user via said communication system.

In case the predetermined user is not accessible, e.g. the user is offline, i.e. the data can not be transmitted to the user, then it is decided whether to store or not to store this data in a storage entity depending on the offline rule associated with said user, wherein said offline rule contains at least one out of (i) at least one accept rule for storing data and (ii) at least one reject rule for not storing data.

Thus, said offline rule defines what to do with offline communication which is intended to be transmitted to the corresponding user in case said user is not accessible.

For instance, a user may define that he does not want to receive any data from at least one certain data source, e.g. a certain user or a group of users, and then the identifier of said at least one data source is listed as at least one reject rule in order to decide that the data from one of said at least one certain data source is not stored in the storage entity.

Furthermore, also the kind of data content, e.g. the media type like voice, video, group advertisement, still images, text, filed or the like may be used as reject and/or accept rule. For instance, in case the user does not want that videos are stored when he is offline then he may put “video” as a special kind of data content on the reject list, and in case he wants that that voice is store, then he may put “voice” as a special kind of data content on the accept list.

Further, also the data size may be a criteria for an accept and/or a reject rule of the offline rule associated with the user. Of course, also other suited criteria may be used for an accept/or a reject rule.

Said decision whether to store or not to store the data in the storage entity depending on the offline rule associated with said user may be performed by a server or by another entity of the communication system, e.g. a controller or the like.

For instance, only if it is decided that the data should be stored in accordance with the offline rule associated with said user, then the data is stored in the storage entity, otherwise no storage is performed.

Thus, the present invention shows the advantage that the user has influence regarding the storage process of data to the storage entity by means of the offline rule, since the user can define rules for deciding which data should be stored and which data should not be stored when he is offline.

In case the offline rule does not clearly specify whether the data should be stored or not, then it may be generally decided to store the data or it may be generally decided not to store the data in step.

It is to be understood that the present invention is not limited to one single offline rule, there may also exist a plurality of offline rules associated with a plurality of users.

According to an exemplary embodiment of the present invention, at least one of said at least one accept rule and said at least one reject rule depends on at least one out of (i) identifier of data source, (ii) kind of data content, and (iii) data size.

According to an exemplary embodiment of the present invention, said content is provided via a server.

For instance, said server may be an application server of said communication system.

According to an exemplary embodiment of the present invention, said deciding is performed by said server.

For instance, the server may receive the corresponding offline communication rule necessary for the decision from the communication system or it may comprise an own storage for storing the offline communication rule.

According to an exemplary embodiment of the present invention, said storage entity is a network storage.

For instance, said server may be PoC server and said network storage may be a PoC Box for storing offline PoC communication.

According to an exemplary embodiment of the present invention, said server comprises said storage entity.

For instance, said server may represent an Instant Messaging Server comprising the storage entity.

According to an exemplary embodiment of the present invention, said data is stored in the storage entity in case it is decided to store the data.

Thus, the data is not stored before the decision is made.

According to an exemplary embodiment of the present invention, the offline rule associated with said user is stored in a memory of the communication system, and said offline rule can be manipulated, e.g. changed, cancelled, or added with new rules, in response to said associated user.

According to an exemplary embodiment of the present invention, said communication system is a group communication system.

Group communication, as used herein, refers to a multipoint communication relationship between members of a group for the purpose of transferring data. Members in the group are defined with special group communication information that associates a specific user with the particular group. Groups are created logically, which means that special group communication information maintained in the system associates a specific user with a particular group. This special group communication information may be stored in a separate server in the group communication system. Said separate server may be a network storage, e.g. a shared document server or an Extensible Markup Language document server or a policy server or a shared policy Extensible Markup Language document server. One user may be a member in one or more groups, and the association can typically be dynamically created, modified and/or cancelled.

The group communication system may comprise at least one application server associated with at least one a service of said group communication system. For instance, this service may be a push-to-talk over Cellular (PoC) service and at least one of said at least one application server may represent a PoC server, or this server may be an Instant Messaging service and at least one of said application server may represent an Instant Messaging server, but this service may be any other kind of group service and the application server may represent a server associated with said service.

Furthermore, the group communication system may comprise at least one interface configured to be connected to at least one user. For instance, this at least one interface may represent an access network.

Thus, for instance, in case during a group communication session a user of said session is not accessible via the network, it can be decided depending on the offline rule associated with said user whether to store the data of said communication session or not.

According to an exemplary embodiment of the present invention, the offline rule associated with said user is stored in a shared document management server.

According to an exemplary embodiment of the present invention, the offline rule associated with said user is stored in an Extensible Markup Language document server.

XML Document Management (XDM) is an Open Mobile alliance (OMA) specification for accessing and manipulating XML documents stored in networked document repositories. The specification is based on the IETF XML Configuration Access Protocol (XCAP) and enables manipulation of individual XML elements and attributes instead of the whole XML document. This reduces the banwidth and processing power requirements significantly.

For instance, an offline rule associated with a user may be part of an XML document stored in a server like one of a shared document management server and an Extensible Markup Language document server. In this case, a user may have access to his offline rule by means of an XML Configuration Access Protocol (XCAP). This may allow manipulating the offline rule of an associated user by the associated user in an easy way, so that the user can change his accept and/or reject rules by using XCAP. Furthermore, a user may have also access by means of XCAP to other user-specific-service-related information stored in the communication system.

According to an exemplary embodiment of the present invention, the offline rule associated with said user is stored in a policy server.

This policy server may be represented by any kind of server that stores policies not described with XML language. For instance, these policies may be described by another language or is defined by other means. Thus, the present invention is not limited to the use of XML for describing the offline rules.

According to an exemplary embodiment of the present invention, the offline rule associated with said user is stored in a shared policy Extensible Markup Language document server (XDMS).

The XDM 2.0 architecture introduces a network element called Shared Policy XDMS, which includes reusable user access policy document for several enabler (e.g. PoC and Instant Messaging) based on PoC 1.0 User Access Policy Document that was stored in PoC XDMS. According to this exemplary embodiment of the present invention, this architecture may be applied for the present invention, and the Shared Policy XDMS may be used to store the offline rule of an user.

Thus, a user may have access to his offline rule stored in the Shared Policy XDM by means of an XML Configuration Access Protocol (XCAP). This allows manipulating the offline rule of an associated user by the associated user in an easy way, so that the user can change his accept and/or reject rules by using XCAP. Furthermore, a user may have also access by means of XCAP to other user-specific-service-related information stored in the communication system.

According to an exemplary embodiment of the present invention, said data is associated with a session in said group communication system.

According to an exemplary embodiment of the present invention, said associated session is a push to talk session which is provided via a push to talk server.

According to an exemplary embodiment of the present invention, said push to talk is push to talk over cellular, said push to talk server is a push to talks over cellular server, and said storage entity is a push to talk over cellular box.

PoC 2.0 introduces a functionality called PoC Box, which stores PoC communication of a user to a network storage when the user is offline. Thus, this exemplary embodiment of the present invention allows to manage the offline storage to the PoC Box according to an offline rule of a user when this user is not accessible via the group communication system.

According to an exemplary embodiment of the present invention, said associated session is an Instant Messaging session which is provided via an Instant Message server.

According to an exemplary embodiment of the present invention, at least one of said at least one accept rule and said at least one reject rule depends on at least one out of:
a user identification,
anonymous user,
kind of data content,
a group identifier,
data size.

The user identification can be seen similar to the identifier of data source mentioned before, so that the user can define from which users he does not want to store data, i.e. by means of setting the user identification of these not-wanted users as reject rule, and he can define from which users he wants to store data, i.e. by means of setting the user identification of these wanted users as accept rule. Similarly, it may be defined that data corresponding to a special group is stored or is not stored by usage of the group identifier as accept rule or reject rule. Furthermore, for instance it may be defined that data from an anonymous user is stored or not stored. The explanations concerning the kind of data content and the data size mentioned above also hold for this second exemplary embodiment.

These and other aspects of the invention will be apparent from and elucidated with reference to the embodiments described hereinafter. The features of the present invention and of its exemplary embodiments as presented above are understood to be disclosed also in all possible combinations with each other.

### BRIEF DESCRIPTION OF THE FIGURES

In the figures show:

FIG. 1: a schematic block diagram of a first exemplary embodiment of a system according to the present invention;

FIG. 2: a schematic block diagram of a second exemplary embodiment of a system according to the present invention;

FIG. 3: a schematic block diagram of a third exemplary embodiment of a system according to the present invention;

FIG. 4: a flowchart of an exemplary embodiment of a method according to the present invention.

### DETAILED DESCRIPTION OF THE INVENTION

FIG. 1 depicts a schematic block diagram of a first exemplary embodiment of a system 100 according to the present invention.

The system 100 may be any communication system 100 suited to be connected to at least one user 110. Said communication system 100 may comprise one network or a plurality of networks being connected to each other (not depicted in FIG. 1).

The communication system 100 may comprise at least one server 120 which is configured to provide data to at least one user 110 or to control the routing of data to at least one user 110 via the communication system 100. For instance, this server may be an Internet server, or it may be an application server intended to provide data associated with said application to one or a plurality of predetermined users 110. For instance, another user 111 may be configured to upload data on said at least one server 120 in order to distribute this uploaded data from this server to said at least one user 110.

The communication system 100 may comprise any kind of interface 150 configured to connect at least on use 110, 111 to said communication system 100.

For instance, said communication system 100 may offer different services to users 110, 111, i.e. subscribers, wherein said at least one server 120 may be configured to enable multiparty conferencing between a plurality of users 110, 111, for example, so-called direct voice communication services. The direct voice communication service may allow a user 111 to engage immediate communication with one or more users 110, e.g. one example of the direct voice communication service may comprise “push to talk over cellular” (PoC) service also known as the PTT (push-to-talk) service. The PoC may be based on Voice over IP (VOIP) technology in cellular networks, such as the GSM/GPRS network, wherein the PoC data is first transmitted from a transmitting user 111 to the server 120, and then the server 120 distributes the PoC data to the predetermined at least one user 110 selected by the transmitting user 111. But also single point to single point services may be offered by said communication system 100.

Another service offered to users 110, 111 may comprise instant messaging, which allows a user 111 to send messages to one or more users, wherein the data of said messages may be first transmitted from a transmitting user 111 to the server 120, and then the server 120 distributes the data to the predetermined at least one user 110 selected by the transmitting user 111.

In the following, said at least one predetermined user 110 is assumed to be a single user 110, but the explanations are not limited to a single user 110 and also hold for a plurality of users 110 predetermined to be provided with data via the communication system 100, e.g. from the server 120.

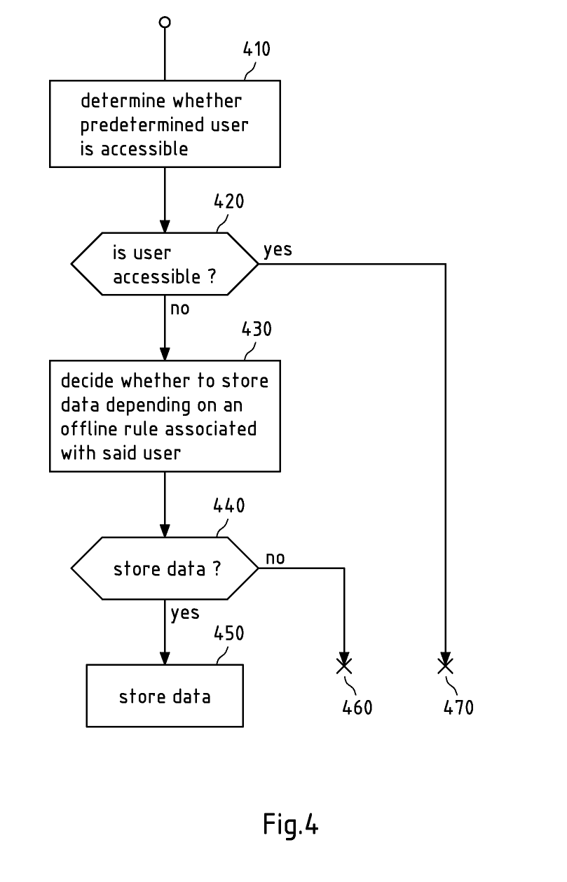

Before the data is provided via the communication system 100, e.g. before the server 110 provides the data to the predetermined user 110 or controls the routing of the data to the predetermined user 120, it is determined whether this user 110 is accessible via the communication system 100, e.g. it checked if the user 110 is online, as depicted in step 410 in FIG. 4. This determining may be performed by the server 120 or any other suited device of the communication system 100, e.g. a controller or the like.

In case the user is accessible (step 420) the server may distribute the data to the user 110.

In case the user 110 is not accessible, i.e. the data can not be transmitted via the communication system to the user 100, e.g. from the server 120 to the user 110, then it is decided whether to store or not to store this data in a storage entity 130 depending on an offline rule associated with said user (step 430), wherein said offline rule contains at least one out of at least one accept rule for storing data and at least one reject rule for not storing data.

Thus, said offline rule defines what to do with offline communication which is intended to be transmitted to the corresponding user 110 in case said user is not accessible, wherein at least one of said at least one accept rule and said at least one reject rule for example may depend on at least one out of:
identifier of data source,
kind of data content, and
data size.

For instance, a user may define that he does not want to receive any data from at least one certain data source, e.g. a certain user or a group of users, and then the identifier of said at least one data source is listed as at least one reject rule in order to decide at step 430 that the data from one of said at least one certain data source is not stored in the storage entity.

Furthermore, also the kind of data content, e.g. the media type like voice, video, group advertisement, still images, text, filed or the like may be used as reject and/or accept rule. For instance, in case the user does not want that videos are stored when he is offline then he may put “video” as a special kind of data content on the reject list, and in case he wants that that voice is stored, then he may put “voice” as a special kind of data content on the accept list.

Further, also the data size may be a criterion for an accept and/or a reject rule of the offline rule associated with the user 110. Of course, also other suited criteria may be used for an accept/or a reject rule.

Said decision whether to store or not to store the data in the storage entity 130 depending on the offline rule associated with said user (step 430) may be performed by the server 120 or by another entity of the communication system 100, e.g. a controller or the like (not shown in FIG. 1).

Only if it is decided that the data should be stored in accordance with the offline rule associated with said user 110, then the data is stored in the storage entity 130 (steps 440 and 450), otherwise no storage is performed (steps 440 and 460).

Thus, the present invention shows the advantage that the user has influence regarding the storage process of data to the storage entity by means of the offline rule, since the user can define rules being used for deciding which data should be stored and which data should not be stored when he is offline.

In case the offline rule does not clearly specify whether the data should be stored or not, then it may be generally decided to store the data or it may be generally decided not to store the data in step 430.

The offline rule may be stored in a storage entity of said system 100, and the corresponding user may have access to the offline rule in said storage entity in order to manipulate the accept and/or reject rules. For instance, said storage entity may be a network storage, e.g. a shared document server or an Extensible Markup Language document server or a policy server or a shared policy Extensible Markup Language document server.

For instance, for each user 110, 111 of the system 100 there may exist an own offline rule.

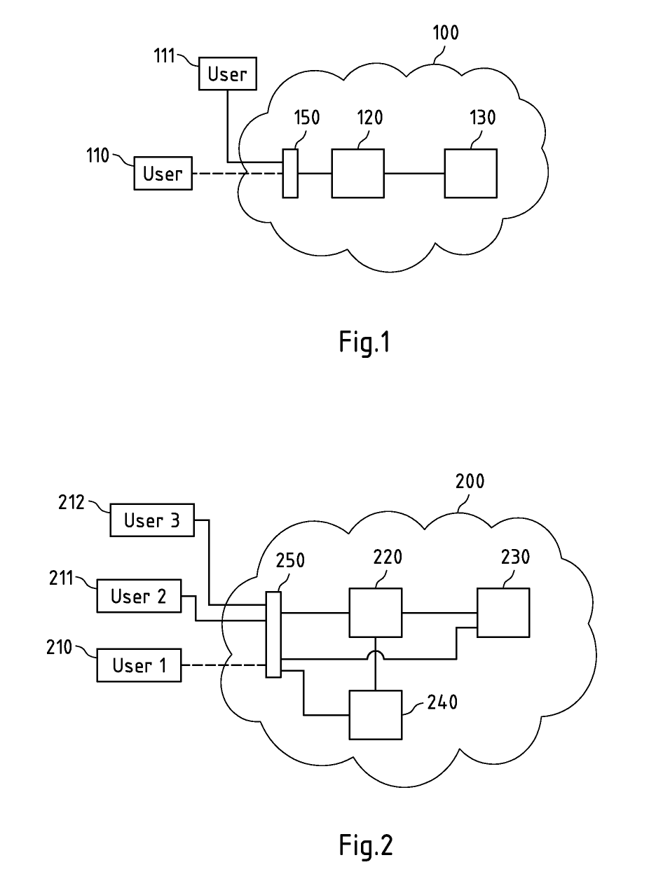

FIG. 2 depicts a schematic block diagram of a second exemplary embodiment of a system 200 according to the present invention.

This system 200 depicted in FIG. 2 represents a group communication system 200 suited to enable group communication between a plurality of users 210, 211, 212. Group communication, as used herein, refers to a multipoint communication relationship between members of a group for the purpose of transferring data. Members in the group are defined with special group communication information that associates a specific user with the particular group. Groups are created logically, which means that special group communication information maintained in the system 200 associates a specific user with a particular group. This special group communication information may be stored in a separate server 240 in the group communication system. Said separate server 240 may be a network storage, e.g. a shared document server or an Extensible Markup Language document server or a policy server or a shared policy Extensible Markup Language document server. One user may be a member in one or more groups, and the association can typically be dynamically created, modified and/or cancelled.

The group communication system 200 comprises at least one application server 220 associated with at least one service of said group communication system 200. For instance, at least one service may be a push-to-talk over Cellular (PoC) service and at least one of said at least one application server 220 may represent a PoC server, and/or at least one service may be an Instant Messaging service and at least one of said at least one application server 220 may represent an Instant Messaging server 220, but this service may be any other kind of group service and the application server 220 may represent a server associated with said service. The explanations mentioned above with respect to the server 120 of the first exemplary embodiment depicted in FIG. 1 also hold for this at least one application server 220 in the environment of the group communication system 200 depicted in FIG. 2.

Furthermore, the group communication system 200 comprises at least one interface 250 configured to be connected to the users 210, 211, 212. For instance, this at least one interface 250 may represent an access network.

The separate server 240 may be used to store the offline rule for at least one of the users 210, 211, 212. Furthermore, the group communication system comprises at least one storage entity 230 configured to store data as explained with respect to the storage entity 130 of the first exemplary embodiment depicted in FIG. 1. For instance, in case said application server 220 represents a PoC server then at least one of said at least one storage entity 230 may represent a network PoC box.

For instance, in case a group communication session is initiated by one of the users 210, 211, 212, e.g. by a first user 212, wherein it is intended to provide data from the first user 212 to the other members of a group, e.g. to users 211 and 210, then the corresponding application server of said at least one application server 220 may at first determine whether a predetermined user of the users 211 and 210 is accessible via the group communication system 200, as depicted in step 410 in FIG. 4. For instance, user 211 is offline and thus not accessible. Then, it is determined in step 410 that this user is not accessible and the application server has to decide whether the data of said group communication session which is intended to be provided to the non-accessible user 211 should be stored at the storage entity 230 or should not be stored, as depicted in step 430 in FIG. 4. In order to perform this decision the application server reads the offline rule associated with said user 211 from the separate server 240, and depending on this offline rule, it is decided whether to store the data or not, as explained in detail with respect to the first embodiment.

For instance, said offline rule may comprise at least one of at least one accept rule and at least one reject rule depending on at least one out of:
a user identification,
anonymous user,
kind of data content,
a group identifier,
data size.

The user identification can be seen as similar to the identifier of data source mentioned before, so that the user can define from which users he does not want to store data, i.e. by means of setting the user identification of these not-wanted users as a reject rule, and he can define from which users he wants to store data, i.e. by means of setting the user identification of these wanted users as an accept rule. Similarly, it may be defined that data corresponding to a special group is stored or is not stored by usage of the group identifier as an accept rule or a reject rule. Furthermore, for instance it may be defined that data from an anonymous user is stored or not stored. The explanations concerning the kind of data content and the data size mentioned above with respect to first exemplary embodiment also hold for this second exemplary embodiment.

Of course, also other suited criteria may be used for an accept/or a reject rule.

Thus, the present invention shows the advantage that a user has influence regarding the storage process of data to the storage entity by means of the offline rule, since the user can define rules being used for deciding which data should be stored and which data should not be stored when he is offline.

Any of the users 210, 211, 212 may represent or may be associated with a client, wherein said client may be used connect to the communication system 200, e.g. for manipulating the offline rule of a user stored in the separate server 240.

XML Document Management (XDM) is an Open Mobile alliance (OMA) specification for accessing and manipulating XML documents stored in networked document repositories. The specification is based on the IETF XML Configuration Access Protocol (XCAP) and enables manipulation of individual XML elements and attributes instead of the whole XML document. This reduces the banwidth and processing power requirements significantly.

For instance, an offline rule associated with a user 210, 211, 212 may be part of an XML document stored in the separate server 240. In this case, the separate server 240 may represent shared document management server (XDMS), and a user may have access to his offline rule by means of an XML Configuration Access Protocol (XCAP). This allows manipulating the offline rule of an associated user by the associated user in an easy way, so that the user can change his accept and/or reject rules by using XCAP. Furthermore, a user may have also access by means of XCAP to other user-specific-service-related information stored in the communication system 200.

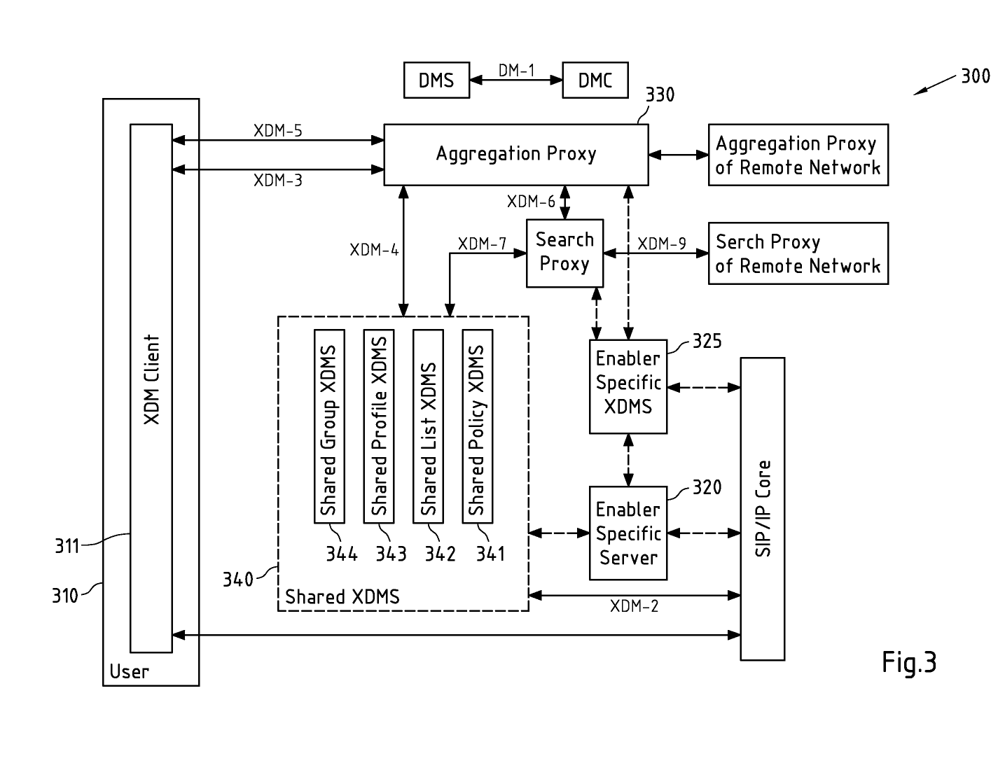

FIG. 3 depicts a schematic block diagram of a third exemplary embodiment of parts of a group communication system according to the present invention exemplifying the present invention in the environment of an XDM architecture 300 as defined by OMA.

The XDM Document Management (XDM) defines a common mechanism that makes user-specific service-related information accessible to the service enablers that need them. Such information is expected to be stored in the network where it can be located, accessed and manipulated (created, changed, deleted, etc.). XDM specifies how such information will be defined in well-structured XML documents, as well as the common protocols for access and manipulation of such XML documents. The XCAP, as defined by IETF, has been chosen as the common XML Document Management protocol.

Main components of the XDM architecture may comprise an XDM client 311, which may be associated with a user 310, an enabler specific server 320, an enabler specific XDM server 325 and shared XDM Servers (XDMS) 340, 341, 342, 343, 344. For instance, said enabler specific XDM server may represent a PoC XDM server or an Instant Messaging Server XDM or any other application specific XDM server, which stores data that is related only for that application and is not common for all applications in a network like data in the Shared XDM server.

An aggregation proxy 330 acts as contact point for XCAP requests from the XDM client 311. The aggregation proxy 330 may authenticate and route the requests to correct XDMS 340, 341, 342, 343, 344.

An XDM Client like the depicted XDM Client 311 may manipulate an XML document by invoking certain HTTP operations on the XDM resource identified in the Request-Uniform Resource Identifier (URI) of the HTTP header. The client shall construct the Request-URI based on its knowledge of the application usage governing that XML document.

Authorized users 310 can create, change, and delete XML documents stored in the repository 340 with an XDM Client 311. Authorization can be performed by subscribing which may be addressed either by owner's Session Initiate Protocol (SIP) URI or by the Public Service Identity (PSI) URI of the group. Also an applicaiton server can subscribe to changes in the XML documents.

The XDM 2.0 architecture introduces a new network element called Shared Policy XDMS 341, which includes reusable user access policy document for several enablers (e.g. PoC and Instant Messaging) based on PoC 1.0 User Access Policy Document that was stored in PoC XDMS.

Furthermore, PoC 2.0 introduces a functionality called PoC Box, which stores PoC communication of a user to a network storage (not depicted in FIG. 4) when the user is offline. A similar kind of functionality is also in SIMPLE IM 1.0 called deferred message, where messages sent to a user are stored in a network storage when user is offline and the saved messages are forwarded to this uses when he get back to online.

According to the present invention, the offline rule associated with a user is stored in the Shared Policy XDMS 341 in order to define what to do with offline communication as explained in the previous exemplary embodiments.

Thus, the enabler specific server 320 can read the offline rule of a non-accessible user from the Shared Policy XDMS 341 in order to decide whether to store or not to store data according to the flowchart depicted in FIG. 4 and as explained in the previous exemplary embodiments.

A user 310 may manipulate his offline rule by means of the XDM client 311 via the aggregation proxy 330.

Besides the offline rule, the Shared Policy XDMS 341 may also contain a lot of criteria on how communication from certain user or groups can be blocked/allowed when a user is online.

Thus, the present invention allows defining separate offline rules for different handling for storing data of offline communication.

It is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. Said computer software may be stored in a variety of storage media of electric, magnetic, electromagnetic or optic type and may be read and executed by a processor, such as for instance a microprocessor. To this end, said processor and said storage medium may be coupled to interchange information, or the storage medium may be included in the processor.

The invention has been described above by means of exemplary embodiments. It should be noted that there are alternative ways and variations which are obvious to a skilled person in the art and can be implemented without deviating from the scope and spirit of the appended claims. In particular, the present invention is not limited to application in XML systems.

What is claimed is:

1. A method, comprising:
determining whether a predetermined user is accessible via a communication system, wherein it is intended to provide data to said predetermined user via said communication system, and
in case said user is not accessible, deciding whether to store or not to store said data in a storage entity depending on an offline rule associated with said user, wherein said offline rule contains at least one out of:
at least one accept rule for storing data, and
at least one reject rule for not storing data.

2. The method according to claim 1, wherein at least one of said at least one accept rule and said at least one reject rule depends on at least one out of:
identifier of data source,
kind of data content, and
data size.

3. The method according to claim 1, wherein said content is provided via a server.

4. The method according to claim 1, wherein said deciding is performed by said server.

5. The method according to claim 1, wherein said storage entity is a network storage.

6. The method according to claim 3, wherein said server comprises said storage entity.

7. The method according to claim 1, further comprising:
storing said data in the storage entity in case it is decided to store the data.

8. The method according to claim 1, wherein the offline rule associated with said user is stored in a memory of the communication system, the method further comprising a step for manipulating said offline rule in response to said associated user.

9. The method according to claim 1, wherein said communication system is a group communication system.

10. The method according to claim 9, wherein the offline rule associated with said user is stored in a shared document management server.

11. The method according to claim 9, wherein the offline rule associated with said user is stored in an Extensible Markup Language document server (XDMS).

12. The method according to claim 9, wherein the offline rule associated with said user is stored in a policy server.

13. The method according to claim 9, wherein the offline rule associated with said user is stored in a shared policy Extensible Markup Language document server.

14. The method according to claim 9, wherein said data is associated with a session in said group communication system.

15. The method according to claim 14, wherein said associated session is a push to talk session which is provided via a push to talk server.

16. The method according to claim 15, wherein said push to talk is push to talk over cellular, said push to talk server is a push to talks over cellular server, and said storage entity is a push to talk over cellular box.

17. The method according to claim 14, wherein said associated session is an Instant Messaging session which is provided via an Instant Message server.

18. The method according to claim 9, wherein at least one of said at least one accept rule and said at least one reject rule depends on at least one out of:
a user identification,
anonymous user,
kind of data content,
a group identifier,
data size.

19. A computer-readable medium having a computer program stored thereon, the computer program comprising:
determining whether a predetermined user is accessible via a communication system, wherein it is intended to provide data to said predetermined user via said communication system, and
in case said user is not accessible, deciding whether to store or not to store said data in a storage entity depending on an offline rule associated with said user, wherein said offline rule contains at least one out of:
at least one accept rule for storing data, and
at least one reject rule for not storing data.

20. The computer-readable medium according to claim 19, wherein at least one of said at least one accept rule and said at least one reject rule depends on at least one out of:
identifier of data source,
kind of data content, and
data size.

21. An apparatus, comprising a processing component configured to:
determine whether a predetermined user is accessible via a communication system, wherein it is intended to provide data to said predetermined user via said communication system, and
in case said user is not accessible, decide whether to store or not to store said data in a storage entity depending on an offline rule associated with said user, wherein said offline rule contains at least one out of:
at least one accept rule for storing data, and
at least one reject rule for not storing data.

22. The apparatus according to claim 21, wherein at least one of said at least one accept rule and said at least one reject rule depends on at least one out of:
identifier of data source,
kind of data content, and
data size.

23. The apparatus according to claim 21, wherein said server comprises said storage entity.

24. The apparatus according to claim 21, wherein said processing component is further configured to initiate storing said data in the storage entity in case it is decided to store the data.

25. The apparatus according to claim 21, wherein said communication system is a group communication system.

26. The apparatus according to claim 21, wherein the offline rule associated with said user is stored in a memory of said communication system, and wherein said processing component is further configured to read in the offline rule associated with said user from said memory before deciding whether to store or not to store said data.

27. The apparatus according to claim 25, wherein said memory is localized in a shared policy Extensible Markup Language document server.

28. The apparatus according to claim 21, wherein said data is associated with a session in said group communication system.

29. The apparatus according to claim 28, wherein said apparatus represents an enabler specific server configured to provide said session.

30. The apparatus according to claim 29, wherein said associated session is a push to talk session and said enabler specific server represents a push to talk server.

31. The apparatus according to claim 29, wherein said associated session is an Instant Messaging session and said enabler specific server represents an Instant Message server.

32. The apparatus according to claim 28, wherein at least one of said at least one accept rule and said at least one reject rule depends on at least one out of:
a user identification,
anonymous user,
kind of data content,
a group identifier,
data size.

33. A system comprising:
an apparatus according to claim 21,
said storage entity, and
at least one interface configured to connect at least one user to said system.

34. The system according to claim 33, further comprising a server configured to store at least one offline rule associated with at least one user, wherein an offline rule of said at least one offline rule can be manipulated by the associated user via an interface of said at least one interface.

35. The system according to claim 31, wherein said system is a group communication system, said group communication system further comprising:
a shared policy Extensible Markup Language document server configured to store at least one offline rule associated with said at least one user.

36. The system according to claim 35, wherein an offline rule of said at least one offline rule can be manipulated by the associated user via an interface of said at least one interface by means of an Extensible Markup Language Configuration Access Protocol.

37. An apparatus, comprising means for determining whether a predetermined user is accessible via a communication system, wherein it is intended to provide data to said predetermined user via said communication system, and, in case said user is not accessible, for deciding whether to store or not to store said data in a storage entity depending on an offline rule associated with said user, wherein said offline rule contains at least one out of at least one accept rule for storing data and at least one reject rule for not storing data.
